(19) United States
(12) Patent Application Publication
(10) Pub. No.: US 2003/0208390 A1
(43) Pub. Date: Nov. 6, 2003

(54) On-line system and method for tracking the performance of a selected request-for-proposal vendor or buyer

(76) Inventor: Enrique Posner, New York, NY (US)

Correspondence Address: Robert M. Haroun, SOFER & HAROUN, L.L.P., Suite 1921, 342 Madison Avenue, New York, NY, 10173, US

(21) Appl. No.: 09/754,843

(22) Filed: Jan. 4, 2001

Related U.S. Application Data
(60) Provisional application No. 60/211,719, filed on Jun. 15, 2000.

(51) Int. Cl. G06F 17/60

(52) U.S. Cl. 705/8; 705/7; 705/9

(57) ABSTRACT

An on-line system and method for tracking the performance of a vendor. The system comprises a purchaser terminal and a vendor terminal. A processor is coupled to the purchaser terminal and to the vendor terminal via Internet. The system also comprises scheduling data storage means which is coupled to the processor and which stores scheduling data, including a date. The processor is configured to generate and transmit to the vendor terminal, on the date stored in the scheduling data storage means, a notification message. The notification message requires a knowledgeable person at the vendor terminal to indicate whether a deadline has been or will be met. The processor is also configured to receive, in response to the notification message, a response message from the vendor terminal, and to distribute the response message to interested parties.

### CROSS-REFERENCE TO RELATED APPLICATIONS

This application claims the benefit of priority of U.S. Provisional Patent Application Serial No. 60/211,719, filed on Jun. 15, 2000, and is related to Applicant's co-pending applications, identified as Attorney Docket Nos. 878-006, 878-007, 878-008 and 878-011. Each of these applications, including the above-referenced provisional application, is incorporated by reference herein as fully as if set forth in its entirety.

### FIELD OF THE INVENTION

This invention relates to a system and method for processing and managing data corresponding to RFP's (“requests-for-proposal”), and more particularly, to an on-line system and method for tracking the performance of a selected RFP vendor or buyer.

### BACKGROUND OF THE INVENTION

Many goods which are purchased by a large industrial entity (e.g.—utility and/or energy companies) may be purchased over-the-counter. These type of goods are typically employed by the industrial facility for the maintenance, repair and operation of the facility, and are often referred to as “MRO” products. Since these products are relatively common, they may be purchased from a catalog. Alternatively, they may be purchased on-line in the typical fashion, whereby a user visits the website of a vendor and orders the product described on the web site.

However, there are many goods which can not be purchased over-the-counter by a large industrial entity. Highly engineered goods typically fall into this category, as they are very often required by an industrial entity but can not be purchased in the typical on-line fashion described above. Highly engineered goods, by definition, must meet an industrial entity's specific, and often unique, engineering requirements. Thus, they can not be purchased from a catalog or on-line.

Instead, highly engineered goods are typically procured by an industrial entity by creating a request-for-proposal (referred to hereinafter as an “RFP”). The RFP describes the unique engineering specifications that are required to be incorporated in the product. The RFP is then supplied to vendors that are deemed capable of manufacturing the product in accordance with the required engineering specifications. The vendors' proposals are then submitted to the industrial entity for its consideration.

While the above-described RFP system is very commonly employed by industrial entities, there is currently no system or method which provides an optimal workflow and collaboration capabilities in the creation, management and tracking of RFP's in an on-line environment. Thus, there exists a need for such a system and method.

### SUMMARY OF THE INVENTION

The present invention, in accordance with one embodiment, provides a system and method for tracking the performance of an RFP vendor in an on-line environment, and for using the performance data compiled by the system in order to determine the vendor's eligibility to receive other RFPs in the future. Although not limited thereto, the system and method of the present invention is particularly well-suited to utility and energy companies, which often require highly engineered goods made to unique specifications. For the purposes of this application, the entity making an RFP is referred to hereinafter as a “purchaser” and the entity which responds to the RFP and performs the project required by the RFP is referred to hereinafter as a “vendor”. It is noted, however, that the present invention is not intended to be limited in scope to any particular type of purchaser or vendor, nor to any particular type of good.

In a preferred embodiment, the system comprises a network of at least one purchaser terminal for entering RFP data and a network of at least one vendor terminal for entering proposal data. The RFP data may include, but is not limited to, the name and type of product desired, the unique engineering specifications that the product must meet, as well as scheduling terms, payment terms etc. The proposal data may include, but is not limited to, the name and type of product which is available, an explanation of how the available product meets the specified engineering requirements, the price and availability of the product, etc.

The system also comprises a processor having a web server, which is configured to maintain an addressable web site for providing interfaces to users of the purchaser and vendor terminals. The processor comprises an analytics module. The analytics module is configured to generate notification messages to a vendor at various stages of an RFP project, inquiring whether the vendor is going to meet interim deadlines during the project. The RFP vendor responds by transmitting notification response messages to the system, indicating that the deadline has, or is going to be met, or else indicating that the deadline is not going to be met. The system of the present invention then distributes the notification response messages to others that are effected by the vendors timely performance, such as other vendors involved in the project or persons at the purchaser company that are responsible for monitoring the vendor.

The analytics module is also configured to store in a vendor performance data storage module a record of the vendor's notification response messages. Data from the vendor performance data storage module is then employed by the processor in order to determine a vendor's eligibility to receive future RFP broadcasts, insuring that vendors that bid on RFPs meet a minimum standard of reliability.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a diagram that illustrates the salient features of an on-line RFP management system, in accordance with one embodiment of the present invention;

FIG. 2 is a diagram that illustrates the storage arrangement of scheduling data in a scheduling data storage module, in accordance with one embodiment of the invention;

FIG. 3 is a diagram that illustrates the storage arrangement of notification data in an event notification data storage module, in accordance with one embodiment of the invention;

FIG. 4 is a diagram that illustrates the storage arrangement of vendor performance data in a vendor performance data storage module, in accordance with one embodiment of the invention;

FIG. 5 is a flowchart that illustrates the steps that are performed by an analytics module to generate notification messages to a vendor and to receive and distribute the vendor's reponses, in accordance with one embodiment of the invention;

FIG. 6 is an interface that is employed in order to display scheduling data, in accordance with one embodiment of the invention; and

FIG. 7 is a flowchart that illustrates the steps that are performed in order to employ vendor performance data to determine the eligibility of vendors to receive a broadcast of an RFP, in accordance with one embodiment of the invention.

### DETAILED DESCRIPTION OF THE INVENTION

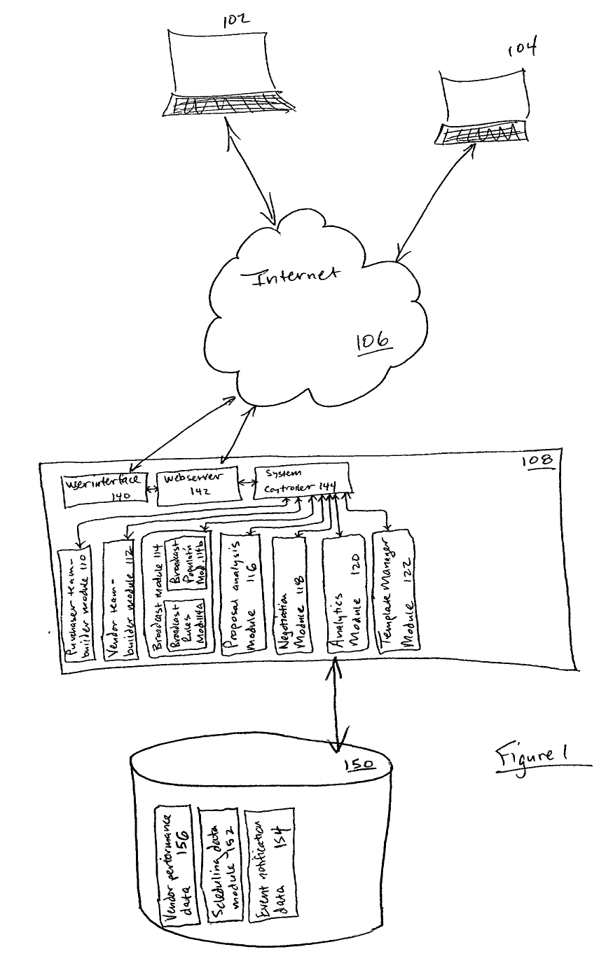

In accordance with one embodiment, the present invention is directed to a system and method for creating, managing and tracking RFP's in an on-line environment. The salient features of the present invention according to one embodiment, are shown in FIG. 1. Although not limited thereto, the present invention is advantageously employed by utility and energy companies that require highly-specialized or engineered products.

FIG. 1 illustrates a communications system 100, in accordance with one embodiment of the present invention. In the embodiment shown, vendor terminal 102 and purchaser terminal 104, such as personal computers, hand-held devices or the like, are coupled to Internet 106. Also coupled to Internet 106 is processor 108.

Processor 108 comprises web server 142 which is configured to maintain an addressable web site. Processor 108 also comprises viewer display interface 140 that provides an interface for users of the computer terminals to communicate with processor 108, as will be described further below. System controller 144 is coupled to web server 142, and controls the operation of processor 108. Processor 108 also comprises modules which perform various operations (although it is noted that these modules need not be discrete components but may instead be any combination of components, or software, which provide the desired functionality described below).

According to one embodiment of the invention, processor 108 comprises purchaser team builder module 110, which is configured to receive and process request data from one or more of the purchaser terminals. Purchaser team builder module 110 provides a workflow that enables the users of the one or more purchaser terminals to collaborate in the creation of an RFP.

Processor 108 also comprises vendor team builder module 112, which is configured to receive and process proposal data from one or more of the vendor terminals. Vendor team builder module 112 provides a workflow that enables the users of the one or more purchaser terminals to collaborate in the creation of a proposal in response to the purchaser's RFP.

Processor 108 may also comprise broadcast module 114, which is configured to broadcast the requested data to a desired number of vendors. Broadcast module 114 may also comprise a broadcast rules module 114a and a broadcast population module 114b. In a preferred embodiment, the broadcast rules module 114a comprises the requirements that must be met by a particular vendor in order to receive the broadcast of an RFP. The broadcast population module 114b, on the other hand, is configured to store data corresponding to all of the vendors that may be used.

Processor 108 may also comprise proposal analysis module 116. Proposal analysis module 116 is configured to receive and process proposals that are received from various vendors and, advantageously, to generate a proposal tabulation that identifies the vendor which is the most suitable to receive the order. Processor 108 may also comprise a negotiation module 118, which is configured to enable the purchaser and vendor to communicate directly with each other via e-mail in order to negotiate the terms of the order.

In a preferred embodiment, processor 108 also comprises analytics module 120. Analytics module 120 is configured to track a project by ascertaining its progress at various stages of production. The analytic data generated by analytics module 120 may advantageously be mined for various reasons. For instance, data corresponding to a particular vendor's on-time delivery performance may be processed for use by the broadcast module 114 in order to determine whether the vendor will receive future RFP's via broadcast.

Processor 108 may also comprise template manager module 122. Template manager module 122 is configured to enable a user to either create new templates (e.g.—engineering templates, legal templates, etc.) or to select from existing templates from a template library. The templates that are generated by template manager module 122 provide a predetermined format for storing data entered by users, thereby allowing efficient storage and evaluation of pertinent RFP data.

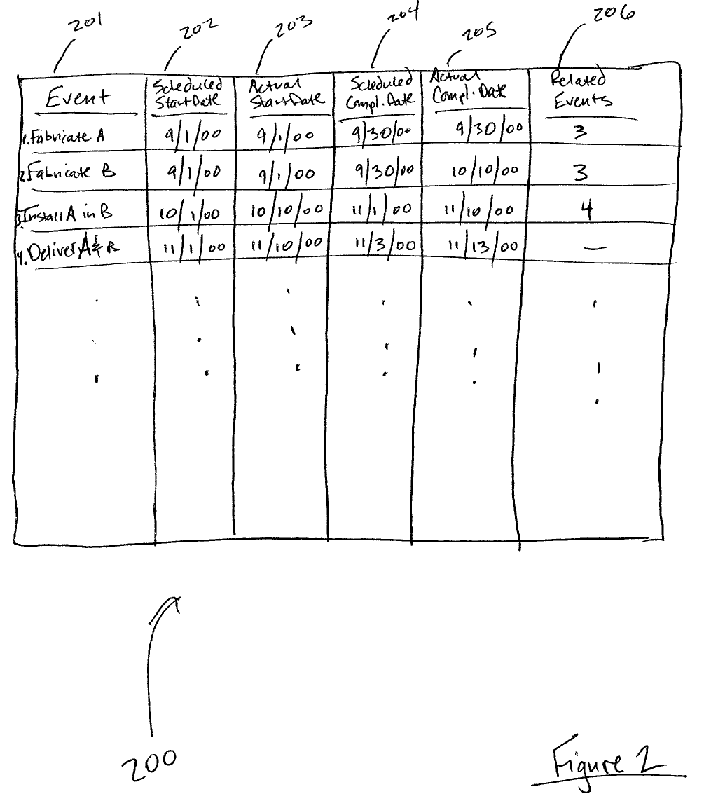

Processor 108 is also coupled to database 150, which is configured to store data. Processor 108 accesses database 150 in order to retrieve stored data when necessary. Database 150 may comprise scheduling data storage module 152, which stores data corresponding to the scheduling of a project. Advantageously, scheduling data storage module 152 stores data corresponding to the events which are required to be completed by a vendor in performing a project. Scheduling data storage module 152 also stores relevant dates for each of the events during a project, and defines the order in which the events occur. FIG. 2, which is explained in detail below, illustrates the format of scheduling data storage module 152, in accordance with one embodiment of the present invention.

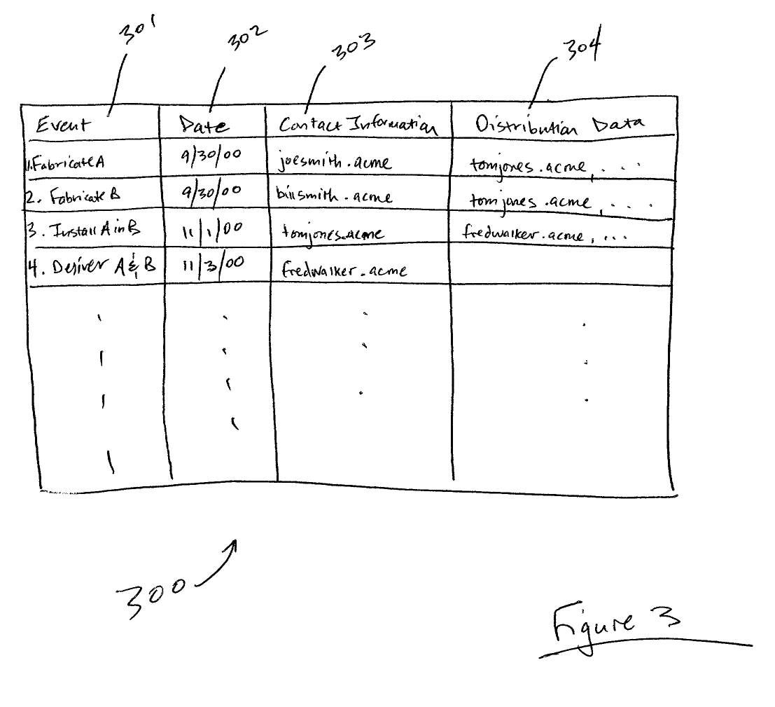

Furthermore, database 150 may comprise event notification data storage module 154, which stores data corresponding to the notifications or alarms that are required in order to keep parties apprised of the progress of a particular project. Advantageously, event notification data storage module 154 stores data corresponding to the person or persons that can provide information regarding the progress of the events of a project. Event notification data storage module 154 is accessed by processor 108 at relevant milestones in order to determine the progress of the project and to communicate progress updates to the relevant parties. FIG. 3, which is explained in detail below, illustrates the format of event notification data storage module 154, in accordance with one embodiment of the present invention.

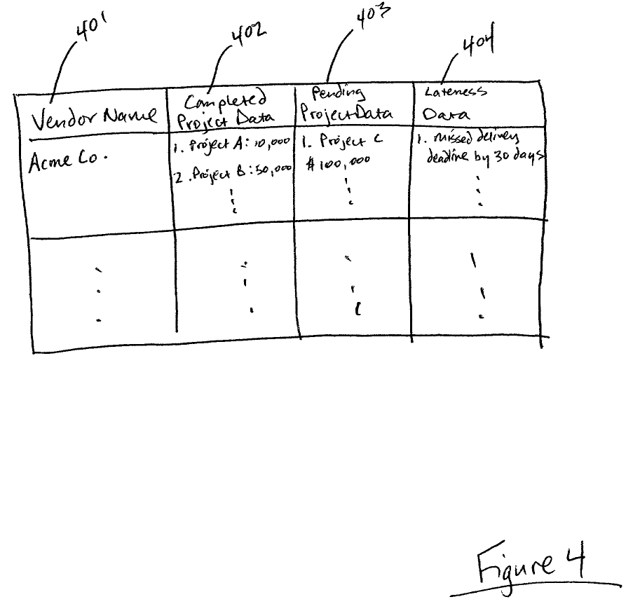

Finally, database 150 may also comprise vendor performance data storage module 156, which stores data corresponding to each vendor's performance. Generally, vendor performance data storage module 156 maintains a “report card” of each vendor's performance (e.g.—the number of times that a project performed by the vendor was completed on time, the number of times that the vendor missed a milestone, etc.). Module 156 may store performance data relating to a current project and to projects previously performed by the vendor. FIG. 4, which is explained in detail below, illustrates the format of vendor performance data storage module 156, in accordance with one embodiment of the present invention.

As previously mentioned, FIG. 2 illustrates the format of scheduling data storage module 152, in accordance with one embodiment of the present invention. Scheduling data storage module 152 stores data corresponding to the events which are required to be completed by a vendor in performing a project. For instance, FIG. 2 shows an event field 201. Event field 201 stores a list of events, such as “Fabricate Component A”, “Fabricate Component B”, “Install Component A in Component B”, “Ship to Purchaser”, etc.

FIG. 2 also shows scheduled start date field 202, which stores the date on which the corresponding event is scheduled to be started. Actual start date field 203 stores the date on which the corresponding event actually is started. Scheduled completion date field 204 stores the date on which the corresponding event is scheduled to be completed. Actual completion date field 205 stores the date on which the corresponding event actually is completed. Fields 203 and 205 are updatable in order to reflect the progress of the project. The data in the fields of this module may be entered by a purchaser, or may instead be automatically populated from data in template manager module 122 or negotiation module 118. The manner in which data is stored in template manager module 122 or negotiation module 118 is discussed in Applicant's co-pending applications.

Scheduling data storage module 152 also provides in field 206 a list of other events that are directly effected by the progress of the event. Particularly, field 206 of module 152 lists any other event which is not started until the completion of the present event. For instance, using the example cited above, the events “Fabricate Component A” and “Fabricate Component B” may be worked on concurrently. However, module 152 also establishes via field 206 that the event “Install Component A in Component B” can not be performed until both of these previous steps are completed. Additionally, module 152 establishes that the event “Ship to Purchaser” can not be performed until Component A is installed in Component B. The establishment of these relationships and the maintenance of dates for each is commonly referred to as a “Critical Path” method. The manner by which these dates are updated and conveyed to the relevant parties is discussed in connection with the flowcharts below.

As mentioned above, FIG. 3 illustrates the storage of notification data in an event notification data storage module 154, in accordance with one embodiment of the invention. For instance, FIG. 3 shows event field 301, having events corresponding to those stored in scheduling data storage module 152. FIG. 3 also shows date field 302, which stores the date upon which a notification relating to the event is to be transmitted to the vendor. Contact data field 303 comprises the contact information for a person at the vendor who is most knowledgeable about the date upon which the event is to be completed, while distribution data field 304 comprises additional contact data for transmitting the vendor's response to other persons that need to know the relevant dates concerning the event. This contact information may be entered separately, but is preferably automatically populated by data from team builder modules 110 and 112, the operation of which are discussed in greater detail in Applicant's co-pending applications.

FIG. 4 illustrates the arrangement of data in vendor performance data storage module 156, according to one embodiment of the present invention. As previously mentioned, vendor performance data storage module 156 stores data corresponding to each vendor's performance. Specifically, vendor performance data storage module 156 maintains a record of each vendor's performance for a current project, so that the vendor can be reminded to increase productivity. In addition, vendor performance data storage module 156 maintains a record of each vendor's performance for previously-completed projects, so that the purchaser can determine whether the vendor is suitable to receive a new RFP.

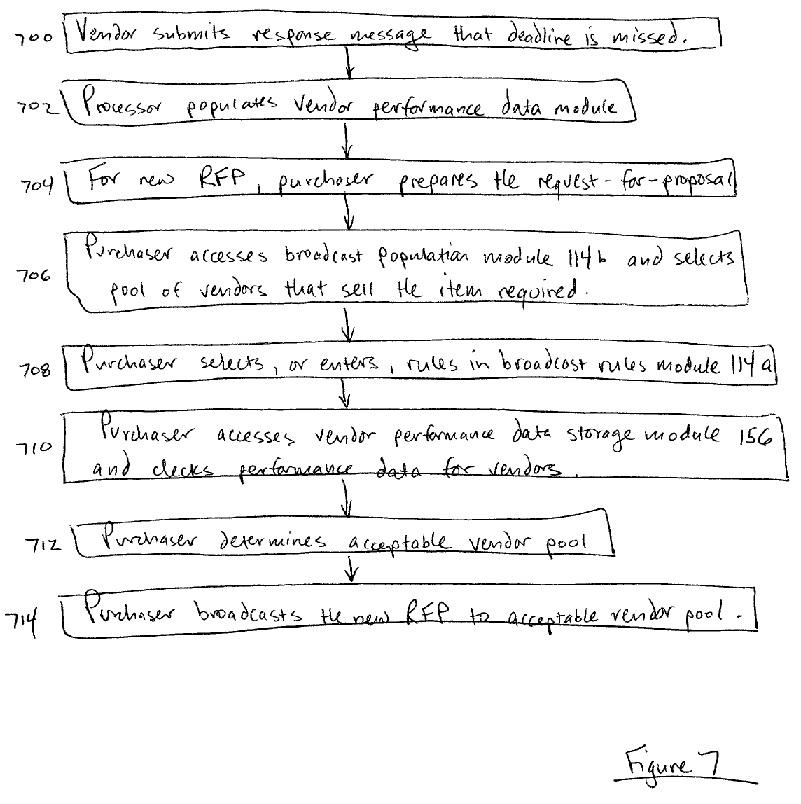

FIG. 4 shows a vendor field 401, which comprises a list of the vendors in the system. Completed projects data section 402 comprises data corresponding to projects that the vendor has completed in the past. This type of data may include the name of a project, the date that the project was started and completed, the price of the equipment, etc. Current projects data section 403 comprises data corresponding to projects that the vendor is currently working on. Lateness data section 404 comprises data corresponding to the number of times that the vendor missed a deadline, failed to deliver equipment on time, etc. Advantageously, module 156 may be accessed by broadcast module 114 of processor 108 in order to obtain data in prior to determining which vendors should receive the broadcast of an RFP, as is explained in the flowchart of FIG. 7 below.

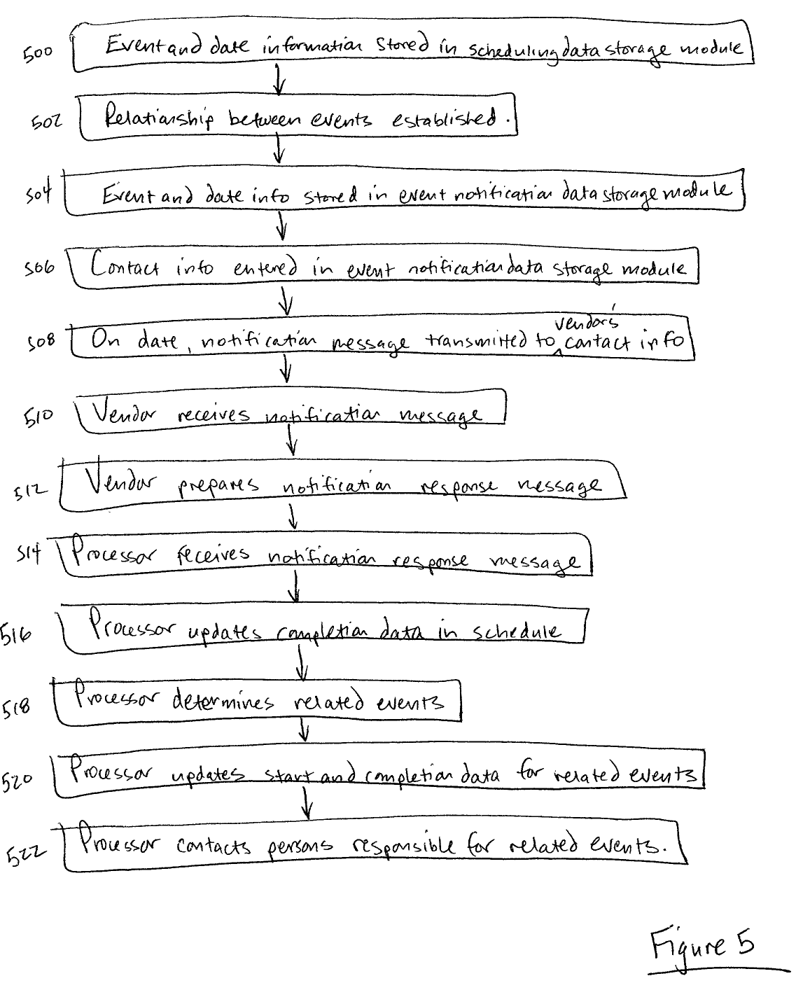

FIG. 5 is a flow chart that illustrates the steps that are performed, in accordance with one embodiment of the invention, in order to track the performance of a selected vendor during a project. It is noted that the steps that are illustrated in FIG. 2 are merely exemplary, and greater or fewer number of steps may be employed in order to accomplish the same functions as described herein. At step 500, event and date information is entered into the various fields of scheduling data storage module 152. As previously mentioned, this data may be entered by a purchaser, or may instead be automatically populated from scheduling data in template manager module 122 or negotiation module 118. At step 502, the relationships between events is entered into field 206 of scheduling data storage module 152. Although this data may be automatically populated from data in other modules of processor 108, it is likely to be entered by a purchaser.

At step 504, event data and corresponding date information is entered in event field 301 and date field 302, respectively, of event notification data storage module 154. In one embodiment, fields 301 and 302 are automatically populated with event and date information from event and date information from fields 201 and 202 of scheduling data storage module 152, although this is not required. The event and date information may also be entered by a person manually.

At step 506, the contact information for relevant persons is entered in contact data field 303 and distribution data field 304 of event notification data storage module 154. In one embodiment, fields 303 and 304 are automatically populated with contact information, such as e-mail addresses, from teambuilder modules 110 and 112 of processor 108. However, the contact and distribution data may also be entered by a person manually.

At step 508, on the date stored in date field 302 of event notification data storage module 154, analytics module 120 of processor 108 transmits a notification message to the person identified in contact data field 303. The notification message may take any variety of forms, but preferably comprises a query, asking the contact person whether a deadline relating to a particular event will be, or has been, met.

At step 510, the contact person receives the notification message. At step 512, the contact person prepares and transmits to processor 108 a notification response message. Preferably, the notification response message indicates whether a deadline relating to the particular event will be, or has been, met. If the contact person indicates that the deadline will not be met, then the notification message preferably permits the contact person to provide a new date on which the deadline will be met.

At step 514, processor 108 receives the notification response message from the vendor. At step 516, if the contact person has entered a new date, processor 108 updates actual completion date field 205 of scheduling data storage module 152. At step 518, processor 108 reads field 206 in order to determine which other events are effected by the delay in completing the present event. At step 520, for those events that are effected, processor 108 updates actual start date and actual completion date fields 203 and 205 in order to reflect the delay.

At step 522, for each event that was effected by the delay, processor 108 locates the corresponding event in field 301 of event notification data storage module 154 and contacts each of the persons in contact data field 303. Thus, each party that is effected by the delay is cognizant of the effect that the delay has on subsequent steps.

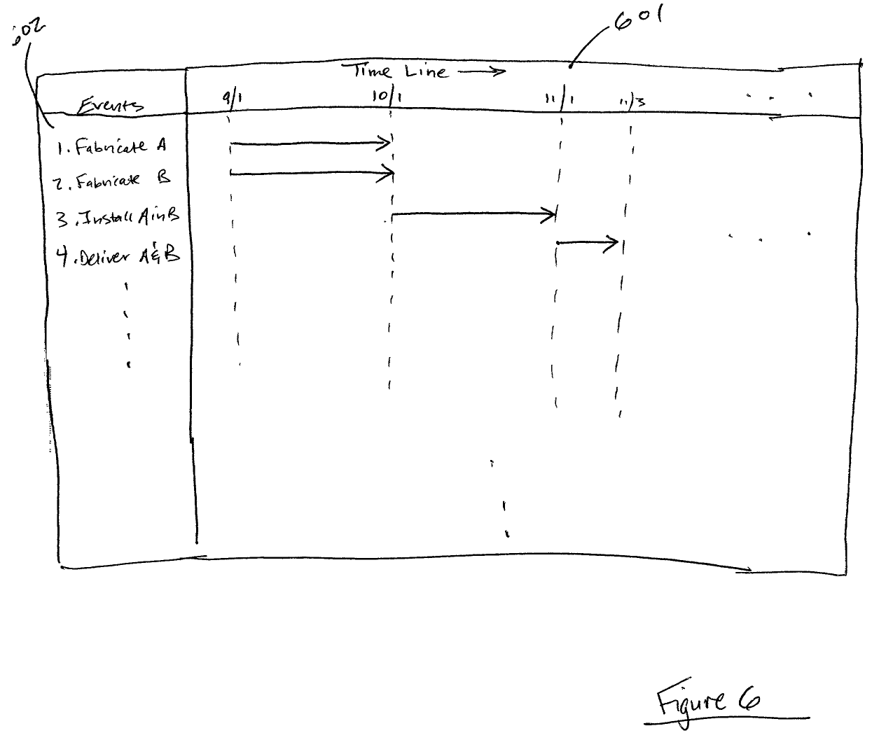

According to one embodiment, analytics module 120 is also configured to generate a schedule interface, using data from scheduling data storage module 152. FIG. 6 is a sample interface 600 that may be employed, according to one embodiment of the invention, to display a project schedule. Time axis 601 provides an indication of time, while event axis 602 lists various events, such as those previously discussed. Preferably, event axis 602 is automatically populated by the event data of fields 201 or 301 shown in FIGS. 2 and 3, respectively.

The start and completion date information of fields 202 through 205 in FIG. 2 is employed to generate time lines corresponding to each event in FIG. 6. For instance, if the start date and completion date for event A is June 1 and June 10, respectively, interface 600 displays a timeline for event A which starts at June 1 on time axis 601 and ends at June 10 on axis 601. By maintaining interface 600, any interested party can view the schedule and the effects that a delay has on subsequent events. In this case, processor 108 may contact effected vendors at step 522 of the flowchart in FIG. 5 by transmitting an e-mail message thereto advising them to review the updated schedule interface 600.

As previously mentioned, vendor performance data storage module 156, which stores data corresponding to each vendor's performance, is employed to maintain a “report card” of each vendor's performance. FIG. 7 is a flowchart that illustrates the steps that are performed, according to one embodiment of the invention, in order to maintain and use the data in vendor performance data. For instance, at step 700, a vendor submits a response to a notification that a deadline has not been, or will be, missed. This response may correspond to the response that the vendor transmits to processor 108 at step 512 of the flowchart shown in FIG. 5.

At step 702, processor 108 populates vendor performance data storage module 156 of database 150. Processor 108 may perform this step by storing in vendor performance data storage module 156 data corresponding to the missed deadline, such as a description of the event that was missed, the date this occurred, the total length of the delay, etc. Preferably, this data is stored in lateness data field 404 of vendor performance data storage module 156, as shown in FIG. 4.

At step 704, a purchaser prepares a new RFP, as explained in detail in Applicant's co-pending application identified as Attorney Docket No. 878-011, which, as previously indicated, is incorporated by reference herein. At step 706, processor 108 accesses broadcast population module 114b. Processor 108 selects from broadcast population module 114b the vendors that sell or make the equipment which is the subject of the RFP.

At step 708, processor 108 accesses broadcast rules module 114a, and enters the performance criteria which the purchaser requires of a vendor. For instance, this performance criteria may specify a maximum number of latenesses in previously-performed projects. Of course, the performance criteria may vary depending on the importance of a project. For instance, for a project that has a very tight deadline, the purchaser may enter a performance criteria which specifies that the maximum number of prior latenesses is zero. Thus, the only vendors that will receive the RFP for such a project will be those vendors that have no prior latenesses on previously performed projects. Similarly, for projects that do not have tight deadlines, the purchaser may enter a performance criteria which specifies a greater maximum number of prior latenesses.

At step 710, processor 108 accesses vendor performance data storage module 156. Processor 108 checks the performance ratings of those vendors that were determined at step 706 to make or sell that equipment that is the subject of the RFP. At step 712, processor 108 determines which of these vendors meets the performance criteria selected in step 708. Then, at step 714, processor 108 broadcasts the new RFP to those vendors that meet the selected performance criteria.

Of course, the present invention also contemplates that processor 108 may be employed to maintain other statistical data. For instance, processor 108 may be employed to generate statistics relating to a vendor's efficiency or the number of RFP's that a particular vendor is participating in. Similarly, processor 108 may be employed to determine and display to interested users a purchaser's consistency of payment or any other type of statistical data relating to a purchaser which may be of interest to another party.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

We claim:

1. A system comprising:
a purchaser terminal;
a vendor terminal;
a means for storing scheduling data, said means configured to store a date; and
a processor coupled to said purchaser terminal and to said vendor terminal via Internet and further coupled to said scheduling data storage means, wherein said processor is configured to generate and transmit to said vendor terminal, on said date stored in said scheduling data storage means, a notification message, to receive in response thereto a response message from said vendor terminal, and to distribute said response message to said purchaser terminal.

2. The system according to claim 1, wherein said scheduling data storage means comprises a plurality of dates, each said date corresponding to one of a plurality of events.

3. The system according to claim 2, wherein said plurality of events corresponds to a plurality of deadlines in a project.

4. The system according to claim 3, wherein said system further comprises a means for storing contact information, coupled to said processor and configured to store, for each said event, contact information corresponding to a user of said vendor terminal who knows if a deadline for said event is met.

5. The system according to claim 4, wherein said processor is configured to transmit said notification message to said contact information corresponding to said event.

6. The system according to claim 5, wherein said scheduling data storage means is further configured to identify, for each said event, at least one related event.

7. The system according to claim 6, wherein said at least one related event corresponds to an event which is effected by a change in a deadline of another event.

8. The system according to claim 7, wherein said contact information storage means is further configured to store contact information corresponding to each said related event.

9. The system according to claim 8, wherein said processor is configured to distribute said response message to said contact information corresponding to said related event.

10. The system according to claim 9, wherein said contact information corresponding to said related event includes contact information corresponding to a third party vendor.

11. A method for tracking a performance of a vendor during a project, said method comprising the steps of:
storing, in a storage means, scheduling data including a date;
generating, by a processor coupled to a purchaser terminal and to a vendor terminal via Internet and further coupled to said scheduling data storage means, a notification message on said date stored in said scheduling data storage means;
transmitting said notification message to said vendor terminal;
receiving in response thereto a response message from said vendor terminal; and
distributing said response message to said purchaser terminal.

12. The method according to claim 11, wherein said method further comprises storing in said scheduling data storage means a plurality of dates, each said date corresponding to one of a plurality of events.

13. The method according to claim 12, wherein said plurality of events corresponds to a plurality of deadlines in a project.

14. The method according to claim 13, further comprising the step of storing, in a contact information storage means coupled to said processor, for each said event, contact information corresponding to a user of said vendor terminal who knows if a deadline for said event is met.

15. The method according to claim 14, further comprising the step of transmitting said notification message to said contact information corresponding to said event.

16. The method according to claim 15, further comprising the step of identifying, for each said event, at least one related event.

17. The method according to claim 16, wherein said at least one related event corresponds to an event which is effected by a change in a deadline of another event.

18. The method according to claim 17, further comprising the step of storing contact information corresponding to each said related event.

19. The method according to claim 18, wherein said distributing step further comprises distributing said response message to said contact information corresponding to said related event.

20. The method according to claim 19, further comprising the steps of:
storing contact information corresponding to a third party vendor and distributing said response message to said contact information of said third party vendor.
